(19) United States
(12) Patent Application Publication
(10) Pub. No.: US 2026/0054719 A1
(43) Pub. Date: Feb. 26, 2026

(54) METHOD FOR CALCULATING A PREDICTED TIME UNTIL A POSSIBLE COLLISION BETWEEN TWO MOTOR VEHICLES, COMPUTER PROGRAM, AND DRIVER ASSISTANCE SYSTEM

(71) Applicant: VALEO SCHALTER UND SENSOREN GMBH, Bietigheim-Bissingen (DE)

(72) Inventors: Julia Granitzka, Bietigheim-Bissingen (DE); Jean-Francois Bariant, Bietigheim-Bissingen (DE); Hanne Groener, Bietigheim-Bissingen (DE)

(73) Assignee: VALEO SCHALTER UND SENSOREN GMBH, Bietigheim-Bissingen (DE)

(21) Appl. No.: 19/111,882

(22) PCT Filed: Sep. 13, 2023
(86) PCT No.: PCT/EP2023/075064

§ 371 Date: Mar. 14, 2025

(30) Foreign Application Priority Data
Sep. 14, 2022 (DE) 10 2022 123 474.6

(51) Int. Cl. B60W 30/095

(52) U.S. Cl. CPC B60W 30/0953; B60W 30/0956; B60W 2520/10; B60W 2554/4044; B60W 2554/802; B60W 2554/804

(57) ABSTRACT

A method for calculating a predicted time until a possible collision between a first motor vehicle and an object is disclosed herein. The method includes ascertaining a travel envelope of the first motor vehicle and representing the object by four corners. The method includes ascertaining the time until the possible collision for a point in time in an interval during which at least one part of the object is located in the travel envelope, based on an absolute first speed of the first motor vehicle and regardless of a second speed of the object in a first situation and based on a relative speed between the first motor vehicle and the object in a second situation. The method includes determining whether the first situation or the second situation is occurring based on the respective position of the four corners relative to the travel envelope.

The invention relates to a method for calculating a predicted time until a possible collision of a first motor vehicle moving in a first movement direction with an object moving in a second movement direction, wherein a travel envelope of the first motor vehicle is ascertained, which describes a predicted area lying in front of the first motor vehicle in the first movement direction and which the first motor vehicle travels over during a future movement of the first motor vehicle, wherein the object is represented by four corners forming a quadrilateral, which are divided into two front corners and two rear corners with respect to the second movement direction, and wherein, for at least one point in time in a time interval during which at least part of the object is located in the travel envelope, the time until the possible collision is ascertained. The invention further relates to a computer program and to a driver assistance system.

Ascertaining the time until a collision or a possible collision is typically the basis of many driver assistance systems which, above all, have the aim of a collision warning or collision avoidance such as, for example, an automatic emergency braking assistant. Depending on the calculated time until the collision, various measures can then accordingly be taken by such a driver assistance system, for example the driver can be warned about an impending collision or an intervention can even be made actively in the course of travel, for example by automatic braking, in order to avoid such a collision. In order to ascertain such a time until a possible collision, first of all a travel envelope of the relevant motor vehicle, in which the aforementioned driver assistance system can be used and which, in the present case, is designated as a first motor vehicle, can be ascertained. In the simplest case, this envelope can be provided by two straight lines, which extend in the current movement direction of the first motor vehicle and are at a distance from each other which corresponds approximately to the width of the first motor vehicle. The prerequisite that a collision with an object is at all possible is, for example, that this object will at least temporarily and at least to some extent stay in this travel envelope. The point in time of the stay must additionally also lie in the time period in which the first motor vehicle reaches the whereabouts of the object. In order for automatic emergency braking assistance systems to ascertain whether the first motor vehicle will collide with an object, the time and the distance as to when and where the collision will take place must be calculated. On the basis of the current movement of the first motor vehicle and of the object, their future positions can be calculated and compared with each other in order to ascertain potential collision points. This can be done by the positions of each object, which means the first motor vehicle and the object, being determined for a plurality of time increments in the future and compared. For example, the positions of the first motor vehicle and of the object can be predicted for discrete future time increments. The interpolation between the last point before the collision and after the collision supplies the time until the collision. This is described, for example, in the dissertation by Thomas Mauer, “Assessment of measurement and prediction uncertainties in the time-based intervention decision for automatic emergency braking and also avoidance systems”. 2013, at the University of Duisburg-Essen, which is published at the Internet addresses https://d-nb.info/1034474758/34 and https://nbn-resolving.org/urn:nbn:de:hbz:464-20130508-152249-6.

This approach is very complicated and therefore unsuitable or at least not preferred for real-time calculations.

Furthermore, it is possible to use the points of intersection of the trajectories and, on the basis of the speeds of the motor vehicle and the object, to estimate whether the two, i.e. motor vehicle and object, will reach this point of intersection at the same time. For this second approach, in principle very many different configurations and scenarios of the collision have to be taken into account, which makes the calculation more difficult. In particular, numerous various situations and special cases have to be taken into account, each of which requires a different mode of calculation. For example, in a simple crossing scenario, according to which, when the object, for example, is likewise a vehicle, the speeds of the vehicles are at a 90° angle to each other, it is sufficient to use the absolute speeds in order to predict whether the motor vehicles will reach the crossing at the same point in time. On the other hand, for road users traveling parallel to one another and behind one another, the relative speed must be taken into account in order to calculate potential collisions.

Furthermore, Jiménez, F.; Naranjo, J. E.; García, F. (2013), An Improved Method to Calculate the Time-to-Collision of Two Vehicles, International Journal of Intelligent Transportation Systems Research, 11 (1), pages 34-42, DOI: 10.1007/s13177-012-0054-4, 2013 Springer, describes various collision scenarios and the associated calculation possibilities for the corresponding time until the collision. Here, too, numerous case distinctions are necessary, for which the time until the collision is calculated differently.

Furthermore, US 2013/0124041 A1 describes a method for the assistance of a driver of a motor vehicle in a driving maneuver, wherein at least the surroundings of the motor vehicle in the direction of travel are monitored in order to detect objects which could possibly collide with the vehicle. In the event of an impending collision with an object, a necessary steering action or braking action is indicated to the driver, or an automatic steering action or an automatic braking action is carried out. The contour of the body of the vehicle is taken into account to ascertain whether a collision with the object is about to happen. However, a time until the collision is not ascertained.

Furthermore, EP 2 837 538 B1 describes a system with a lane detection arrangement of a driving lane and at least one adjacent opposing lane, with a driver detection system for detecting the speed and position relative to the vehicle of another vehicle in the lane in front of the vehicle, an overtaking detection arrangement in order to determine when the vehicle has got into the opposing lane and is carrying out an overtaking maneuver, a vehicle detection system for detecting the relative position and speed of an oncoming vehicle in the opposing lane, and a collision assessment arrangement for determining whether, on the basis of the relative speed and position of the vehicle, the overtaking maneuver can be concluded safely. On the basis of the relative speeds between the vehicle and the oncoming vehicle, it is possible to estimate the time before the two vehicles will collide. This time can then be compared with a limiting value which represents the probable time period which the vehicle still requires to complete the overtaking maneuver.

The ascertainment of the time until the collision is simple here since only this single case, in which a vehicle is approaching on the same lane, has to be taken into account.

However, in general, as already described above, there are numerous different collision scenarios.

It is therefore an object of the present invention to provide a method, a computer program and a driver assistance system which permit the most uniform ascertainment and the simplest possible mathematical description of the ascertainment of a time until a possible collision for as many different collision scenarios as possible.

This object is achieved by a method, a computer program and a driver assistance system having the features according to the respective independent patent claims. Advantageous refinements of the invention are the subject matter of the dependent patent claims, the description and the figures.

In a method according to the invention for calculating a predicted time until a possible collision of a first motor vehicle moving in a first movement direction with an object moving in a second movement direction, a travel envelope of the first motor vehicle is ascertained, which describes a predicted area located in front of the first motor vehicle in the first movement direction and over which the first motor vehicle will travel during a future movement of the first motor vehicle. Furthermore, the object is represented by four corners forming a quadrilateral, which are divided into two front corners and two rear corners with respect to the second movement direction, and, furthermore, for at least one point in time in a time interval during which at least part of the object is located in the travel envelope, the time until the possible collision is ascertained. In a specific first situation, for at least one first point in time during the time interval, the time until the possible collision is ascertained as a function of a current absolute first speed of the first motor vehicle at this first point in time and irrespective of a second speed of the object and, in a specific second situation, for at least one second point in time during the time interval, the time until the possible collision is ascertained as a function of a current relative speed at the second point in time between the first motor vehicle and the object with respect to the current first movement direction at the second point in time. Depending on a respective position of the four corners relative to the travel envelope, a determination is made as to whether this is the first or second situation.

The invention is based on the knowledge that collision scenarios can in principle be divided into two types, specifically those in which taking account of the absolute speed of the first motor vehicle is sufficient for the ascertainment of the time until the possible collision, and those in which the relative speed between the first motor vehicle and the object, for example a second motor vehicle, must be taken into account. The invention is also based on the finding that in most cases a respective situation can be classified as a first or second situation on the basis of the observation of the respective position of the corners of the object. For the special case in which, within the time interval, the second movement direction is perpendicular to the first movement direction, the absolute speed coincides with the relative speed so that, in this situation, it is not even necessary to distinguish between the two situations, not even depending on the positions of the corners of the object with respect to the travel envelope. Thus, all possible situations, including this special case, can be divided simply into one of the two groups and then the time until the collision can accordingly be ascertained as a function of the absolute speed of the first motor vehicle or the relative speed between the first motor vehicle and the object, relative to the first movement direction. This advantageously permits a calculation of the time until the possible collision which is generic and can be applied to numerous different collision situations, in particular both for parallel traffic and also for movement directions of the first motor vehicle and the object that are aligned at any arbitrary angle relative to one another.

The object can in principle be any arbitrary object, in particular any arbitrary road user. However, the representation of the object by four corners is suitable in particular for an object depicted as a vehicle, in particular a motor vehicle, e.g. a passenger car or truck. Therefore, in the following text, for the purpose of simplification and without restricting the generality, the object is to some extent also simply called a second vehicle, in particular a second motor vehicle. The object can in particular be represented by four corners or points which, in a theoretical connection to one another, form a convex quadrilateral, in particular a rectangle or trapezium.

The travel envelope, as described at the start, can be provided as delimited in the simplest case by two straight lines which are at a distance from each other which corresponds to the width of the first motor vehicle. The travel envelope can, for example, also be represented by boundary lines extending in the form of a curve if, for example, the first motor vehicle is traveling in a curve. In addition, the representation of the travel envelope by boundary lines as a polynomial of higher degree is conceivable, although not preferred either because of the increased computing complexity. Also, a trajectory or movement path and in particular just such a second travel envelope can be ascertained for the object on the basis of its movement parameters, such as its speed and movement direction.

One precondition that a collision between the two motor vehicles or the first motor vehicle and the object is at all possible can, for example, consist in that there is an area of intersection between the two travel envelopes. In addition, still further conditions can be placed on the time in which the respective vehicles reach this area of intersection, in order that the collision counts as basically possible. In principle, however, the present method relates to situations, in particular collision scenarios, in which, at least for the case of non-parallel traffic, the object reaches this area of intersection first, wherein reaching the area of intersection is therefore to be equated with the object penetrating or entering the travel envelope of the first motor vehicle. In other words, in the present case only the time interval during which at least part of the object is located in the travel envelope is considered. In the present case, therefore, the predicted time until the possible collision is, for example, estimated at the earliest starting from the point in time, specifically from the first or second point in time, at which the object penetrates into the travel envelope of the first motor vehicle for the first time.

The predicted time until the possible collision is additionally an estimated time, which can deviate from the actual time until the collision. In addition, as already mentioned, the predicted time describes a time period which begins at the first or second point in time which lies within the time interval in which the object is at least partly located within the travel envelope, and ends at the point in time of the theoretical collision.

The parameters first movement direction, second movement direction, first speed and second speed, and also the position of the four corners relative to the travel envelope, and in particular also the ascertainment of the travel envelope itself, in the present case therefore relate to a calculation time which corresponds at the earliest to the point in time at which the object enters the travel envelope. The ascertained time until the possible collision accordingly relates, as described, to an initial point in time which lies within the time interval during which at least part of the object is located within the travel envelope. To simplify the description, this calculation time or this initial point in time is chosen as the current point in time and, accordingly, the above parameters are also designated respectively in part as the current first speed and current second speed and as the current position of the four corners and the current first and second movement directions, and so on. However, it should be noted that this calculation time can also lie in the future in relation to a current traffic scenario. In other words, the actual current point in time then lies before the entry time of the entry of the object into the travel envelope. In this case, for example, it is simply possible to determine where the object will enter the travel envelope at which future point in time and at which time, which can be predicted on the basis of its current second movement direction and the current second speed of the object. For this future point in time, the future first movement direction of the first motor vehicle can also be predicted in a corresponding way on the basis of the current first speed of the first motor vehicle and the ascertained current travel envelope. For an earlier collision prediction, for example, it is additionally also possible to take account of the time which the object needs to reach the travel envelope of the first motor vehicle or else to reach a specific position within the travel envelope. This can then be added to the time ascertained from the entry time into the travel envelope until the possible collision or, in general, to the ascertained time until the possible collision starting from the first and/or the second point in time within the time interval. Accordingly, in the following text, without restricting the generality, it is assumed that the current calculation time or initial point in time for the calculation of the time until the collision lies within the interval.

That it is still a time until the possible collision is to be understood firstly such that by means of optional, preceding method steps, it can firstly be assessed or determined whether a collision between the first motor vehicle and the object is at all possible, for example according to a predetermined criterion. This can be assumed to be met in the present case. Furthermore, a possible collision can also be understood to mean that this collision does not necessarily have to take place even if in principle there is the possibility according to the predetermined criterion that a collision will take place between the first motor vehicle and the object. For example, this collision could be prevented by a timely intervention of a driver assistance system, for example by outputting a warning to the driver, or a driving intervention, in particular a steering and/or braking intervention. The ascertainment of a time until the possible collision is accordingly carried out under the assumption that the current driving situation does not change and the first vehicle continues to move along the ascertained travel envelope at its current first speed, and, in particular, that the object also continues to move in its second movement directions according to its current movement parameters, for example its current second speed.

Whether at least part of the object is located in the travel envelope can in turn be determined by an extremely wide range of criteria. For example, it is determined that at least part of the object is located in the travel envelope if at least one of the corners representing the object is located in the travel envelope. Furthermore, it is also possible to determine that the object is at least partly located in the travel envelope if at least two of the corners of the object are located on different sides of the travel envelope. Whether, therefore, at least part of the object is located in the travel envelope can likewise be established by considering the position of the corners of the object.

The fact that the object is represented by four corners is to be understood in the form of a mathematical representation of the object and not necessarily in the form of a visual illustration. As a result of the representation of the motor vehicle by four corners, the calculations can be simplified highly since, in this way, a simplified geometric model of the object is provided. For the exact ascertainment of the time until the collision, in theory a consideration of each individual contour point of the object would be necessary. This can be simplified by the described procedure and advantageously also by considering four corners, more precisely four points, which represent the corners of the object. This is advantageous in particular for real-time applications.

The absolute speed or the absolute first speed of the first motor vehicle is to be understood here as the magnitude of the first speed of the first motor vehicle in the first movement direction. The relative speed between the first motor vehicle and the object with respect to the first movement direction is to be understood here as the difference between the first speed and the component of the second speed pointing in the first movement direction. If, therefore, for example, the second speed has no component pointing in the first movement direction, as is the case, for example, when the first and the second movement direction are perpendicular to each other, then the relative speed corresponds to the absolute first speed. If, for example, the first and the second speed are aligned in the same direction and are parallel to each other, then the relative speed results as the difference between the magnitude of the first speed and the magnitude of the second speed. If the first and the second movement direction are aligned parallel to each other and opposite to each other, then the relative speed corresponds to the sum of the magnitude of the first speed and the magnitude of the second speed. In other words, the second speed has a speed component pointing in the first movement direction, so, to ascertain the relative speed, the speed components of the first speed and the second speed pointing in the first movement direction are subtracted from each other and, if these speed components are aligned opposite to each other, they are added.

In a further advantageous refinement of the invention, for the case in which, within the time interval, the second movement direction of the object, in particular of a second motor vehicle, is directed perpendicular to the first movement direction, the time until the collision or until the possible collision is determined as a function of the current absolute first speed of the first motor vehicle, which corresponds to the current relative speed. In this case, therefore, the speed component of the second speed that is parallel to the first movement direction is zero. In this case, it therefore makes no difference whether the relative speed or the absolute first speed is taken into account to ascertain the time until the possible collision, since this leads to the same result. This case can therefore be assigned arbitrarily, for example randomly, to the first or second situation.

In order to ascertain whether the movement directions are perpendicular to each other or at which angle or which orientation these are related to each other, for example the speed of the first motor vehicle and its movement direction, as well as the speed of the object and its movement direction, can be detected for example by a sensor, in particular a vehicle surroundings sensor of the first motor vehicle. This information can then accordingly be provided to a control device of the first motor vehicle in order to calculate the time until the collision.

According to a further advantageous refinement of the invention, if the possible collision has not yet taken place, the time until the possible collision is repeatedly ascertained for successive time steps. The calculation of the time until the collision is therefore repeatedly updated. For this purpose, updated captured data, for example the current first speed and/or the current second speed, are correspondingly captured and provided, for example as well as the updated first and second movement directions of the first motor vehicle and of the object.

As a result, the time until the possible collision can be ascertained particularly precisely and even changes in the current movement parameters of the first motor vehicle and of the object can be taken into account.

In a further advantageous refinement, for each of the time steps, a classification is made as to whether this is the first situation or the second situation, depending on a current position of the four corners. In principle, therefore, each time step within the time interval can be assigned to one of the two defined situations. Consequently, the time until the collision is always ascertained as a function either of the absolute first speed or of the relative speed. The definition of further situations is consequently not necessary in order to ascertain the time until the collision. This simplifies the calculations enormously.

In a further advantageous refinement of the invention, an occurrence of the first or second situation is determined as a function of the current position of the four corners in such a way that, depending on which of the four corners is located in the travel envelope, it is classified whether this is the first situation or the second situation. This has the great advantage that the corners have to be classified only as located within the travel envelope or located outside the travel envelope in order to be able to form a classification of a current situation as a first or second situation. If, for example, it is known that one of the specific corners is located within the travel envelope, then the accurate position of this corner within the travel envelope is not relevant. This simplifies the calculations further, since an exact knowledge of the positions of the respective corners is not necessary, at least as long as it can be determined with sufficient accuracy whether the corners are located outside or inside the travel envelope.

In a further advantageous refinement of the invention, it is additionally determined whether this is the first or the second situation, depending on whether, within the time interval, the second movement direction of the object is at least partly directed in the first movement direction or opposite to the first movement direction. For the classification of a current situation as a first or second situation, therefore, in addition to considering the positions of the corners or their location in relation to the travel envelope, the alignment of the respective movement directions of the first motor vehicle and of the object relative to each other can also be taken into account. The consideration of the movement directions relative to each other then in turn permits a particularly simple distinction between cases, as will be explained in more detail later. Once more, the exact angle at which the movement directions are aligned relative to each other does not need to be known; it is already sufficient to know whether the second movement direction at least partly has a directional component opposite to the first movement direction or parallel to the first movement direction or not. If not, this once more corresponds to the special case in which the first and the second movement direction are aligned perpendicular to each other. Since, as described above, for this special case it does not matter whether a calculation is carried out by taking the absolute or relative speed into account, this case also does not need to be considered further below. Therefore, all collision scenarios can again be divided into two groups, specifically depending on whether the second movement direction is directed at least proportionally opposite to the first movement direction or at least proportionally parallel to the same.

In a further advantageous refinement of the invention, for the case in which, within the time interval, the second movement direction of the object points at least partly in the same direction as the first movement direction, it is determined that this is the first situation if or as long as none of the rear corners of the representation of the object are located in the travel envelope and the rear corners are located on the same side of the travel envelope, and that this is the second situation if or as long as a connecting line connecting at least one rear corner or at least part of one of the rear corners is located in the travel envelope. The fact that a connecting line connecting the rear corners is located in the travel envelope corresponds to the two rear corners being located on different sides of the travel envelope. The aforementioned connecting line in turn corresponds to a mathematical model of the representation of the object. As already mentioned, such a connecting line does not necessarily have to be considered. This is because such an imaginary connecting line is located in the travel envelope when the two rear corners of the object are arranged on different sides of the travel envelope. This can specifically be the case, for example, when the second motor vehicle is traveling directly in front of the first motor vehicle in the same movement direction and is considerably wider than the first motor vehicle, so that the rear corners of the second motor vehicle are located on both sides outside the travel envelope of the first motor vehicle. In addition, in this situation, all the corners of the second motor vehicle can be located outside the travel envelope of the first motor vehicle. Since a collision is nevertheless possible, it is possible to detect that the corners of the second motor vehicle or of the object are located on different sides of the travel envelope. Consequently, therefore, the object is also partly located within the travel envelope, and a collision is possible. In this situation too, the relative speed between these two vehicles accordingly has to be taken into account when ascertaining the time until the possible collision. If, therefore, the second movement direction and the first movement direction are at least partly aligned, which means that the object moves in a direction away from the first motor vehicle, then, when ascertaining the time until the possible collision, only the absolute speed of the first motor vehicle has to be taken into account as long as none of the rear corners of the object is located in the travel envelope and, in addition, the rear corners are located on the same side of the travel envelope. In all other cases, when the rear corners are located on different sides of the travel envelope or at least one of the rear corners is located within the travel envelope, the relative speed must be taken into account. This permits a particularly simple differentiation by considering the corners of the object and the respective movement directions relative to one another.

In a further advantageous refinement of the invention, for the case in which, within the time interval, the second movement direction of the object is at least partly opposed to the first movement direction, it is determined that this is the first situation if or as long as none of the front corners of the representation of the object is located in the travel envelope and the front corners are located on the same side of the travel envelope, and that this is the second situation if or as long as at least one of the front corners and/or at least part of a connecting line connecting the front corners is located in the travel envelope. The fact that a connecting line connecting the front corners is located in the travel envelope once more corresponds to the fact that the two front corners are located on different sides of the travel envelope. Therefore, for the case in which the first and the second movement direction are at least partly opposed to each other, which means therefore that the object is traveling in the direction of the first motor vehicle, only then can the absolute speed of the first motor vehicle be used to ascertain the time until the possible collision, as long as none of the front corners of the representation of the object is located in the travel envelope and the front corners are additionally located on the same side of the travel envelope. As soon as one of the front corners enters the travel envelope or the front corners are located on different sides of the travel envelope, the relative speed must be taken into account, since the relative distance between the first motor vehicle and the object decreases, depending on the speed of the object in the direction of the first motor vehicle.

If, for example, the above-described special cases of the perpendicular alignment of the first and the second movement direction and the parallel alignment of the first and the second movement direction relative to each other are also assumed, then the time interval can always be divided into two partial intervals, in which the first situation arises once and the second situation arises once.

Therefore, according to a further advantageous refinement of the invention, provision can be made that, at least when the second movement direction of the object is directed neither completely perpendicular nor completely parallel to the first movement direction, the time interval is divided into two partial intervals, depending on which of the four corners are currently located in the travel envelope, wherein in a first partial interval of the two partial intervals, this is the first situation, and the time until the collision is accordingly ascertained as a function of the current absolute first speed of the first motor vehicle and irrespective of the current second speed of the object, and, in a second partial interval of the two partial intervals, this is the second situation, which means that the time until the collision is accordingly ascertained as a function of the relative speed between the first and the second speed.

In the case of the perpendicular alignment of the movement directions relative to each other, it does not matter, as described, whether the calculation is carried out with the absolute speed or the relative speed and, for the case of parallel travel, the relative speed always has to be taken into account, which means for the complete time interval. Thus, the different collision scenarios can be divided up in a very efficient manner and in principle be divided into two situations, which accordingly permit a particularly efficient calculation of the time until the collision. These two possible situations are additionally divided on the basis of the consideration of the position of the corners of the object, in particular relative to the travel envelope. Depending on a respective classification of these corners, it is thus possible to decide whether this is the first situation and, accordingly, only the absolute speed has to be taken into account, or whether this is the second situation and, accordingly, the relative speed has to be taken into account.

In a further advantageous refinement of the invention, the time until the collision is additionally ascertained depending on a current, in particular shortest, distance between the first motor vehicle and the object, in particular along the travel envelope. Approximately, however, the direct shortest distance between the first object can also be taken. Since the present considerations in any case take place in a very short time period before the collision, this distance is typically also so short that it makes no difference, at least no significant difference, whether this distance is considered along a possibly curved travel envelope or is taken as a direct distance, which means a straight-line distance, between the first motor vehicle and the object. In the case of a travel envelope extending in a straight line, this makes no difference in any case. The distance can be ascertained, for example, by means of suitable sensors of the first motor vehicle. In addition, for the other parameters which are used to calculate the time until the possible collision, appropriate sensors for detecting these parameters can be provided, in particular as a part of the first motor vehicle. Accordingly, it represents a further advantageous refinement of the invention if the time until the possible collision is ascertained by a control device associated with the first motor vehicle, to which control device the current first speed, the second movement direction relative to the first movement direction, the distance to the object and, in particular, the second speed are provided as input variables, in particular for each time step. Therefore, the control device is provided with all the variables required to calculate the time until the possible collision, and the control device can carry out the calculations as described above.

As already described, a sensor of the first motor vehicle can be used to provide these calculation parameters. Accordingly, it represents a further very advantageous refinement of the invention if sensor data relating to the object are provided, in particular captured, by at least one surroundings sensor of the first motor vehicle, as a function of which data the second movement direction relative to the first movement direction, the distance to the object and in particular the second speed are ascertained. The first speed can be provided by a speed sensor of the first motor vehicle. This is typically ascertained in any case in the first motor vehicle and can accordingly likewise be provided to the control device to calculate the time until the possible collision.

In a further advantageous refinement of the invention, a movement path for the object is ascertained and an area of intersection of the movement path with the travel envelope is ascertained, wherein a point in time at which the first motor vehicle reaches the area of intersection is ascertained, wherein the collision is classified as possible when the point in time lies after the entry time at which the object enters the travel envelope and before the exit time at which the object leaves the travel envelope. This can be used as a predetermined criterion described at the beginning in order to classify a potential collision as a collision that is actually possible. If this is therefore not the case, it does not necessarily imply that a collision is not possible. However, if necessary other or further considerations have to be provided. As likewise already mentioned, within the scope of the present invention collisions which take place while the object is already located in the travel envelope are primarily to be considered. For example, it is therefore not considered that the object will drive into the first motor vehicle when the object is about to enter the travel envelope.

Furthermore, the invention also relates to a computer program comprising commands which, when they are executed by a computing unit, cause the computing unit to carry out a method according to the invention or one of its embodiments.

Furthermore, a data carrier, on which a computer program according to the invention or one of its embodiments is stored, should also be viewed as belonging to the invention.

Furthermore, the invention also relates to a driver assistance system for a motor vehicle, wherein the driver assistance system is designed to carry out a method according to the invention or one of its embodiments. The driver assistance system can, for example, comprise the aforementioned computing unit which executes the computer program, or else the data carrier according to the invention or one of its embodiments. In addition, the driver assistance system can also comprise the aforementioned vehicle surroundings sensor or further possible sensors for providing the calculation parameters and calculation variables.

Furthermore, the driver assistance system can, for example, be configured as an emergency braking assistance system. A configuration as a collision warning system or the like is also conceivable. Depending on the ascertained time until the possible collision, the driver assistance system can output a warning to the driver or else carry out automatic braking of the first motor vehicle, for example when the ascertained time until the possible collision is less than a limiting value.

Furthermore, a motor vehicle having a driver assistance system according to the invention or one of its refinements should also be viewed as belonging to the invention.

Further features of the invention can be found in the claims, the figures, and the description of the figures. The features and combinations of features mentioned above in the description and the features and combinations of features mentioned below in the description of the figures and/or shown on their own in the figures may be used not only in the respectively indicated combination but also in other combinations without departing from the scope of the invention. Embodiments of the invention that are not explicitly shown and explained in the figures but emerge and are producible from the explained embodiments by separate combinations of features, should therefore also be regarded as included and disclosed. Embodiments and combinations of features that thus do not have all the features of an originally formulated independent claim should also be regarded as disclosed. Furthermore, embodiments and combinations of features that go beyond or deviate from the combinations of features outlined in the back-references of the claims should be regarded as disclosed, in particular by the embodiments outlined above.

Exemplary embodiments of the invention will be described below with reference to the figures. In the figures:

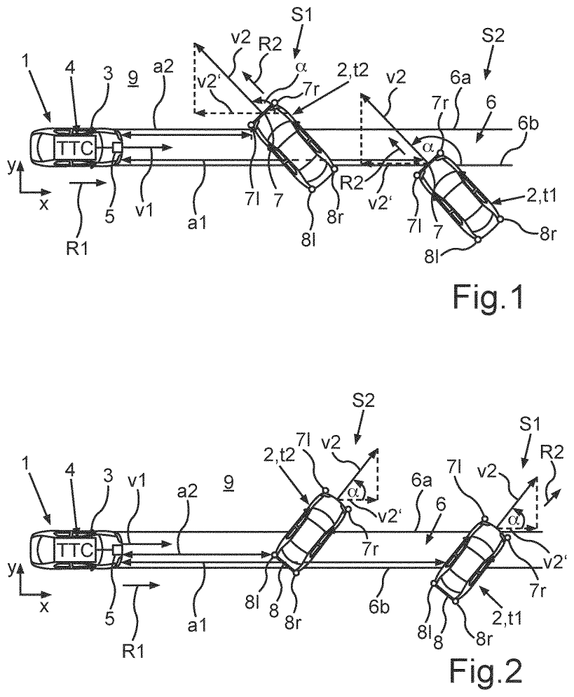

FIG. 1 shows a schematic illustration of a first motor vehicle and a second motor vehicle at different points in time to illustrate a method for calculating a time until the collision according to an exemplary embodiment of the invention;

FIG. 2 shows a schematic illustration of the motor vehicle from FIG. 1 with a second motor vehicle in another traffic situation according to an exemplary embodiment of the invention:

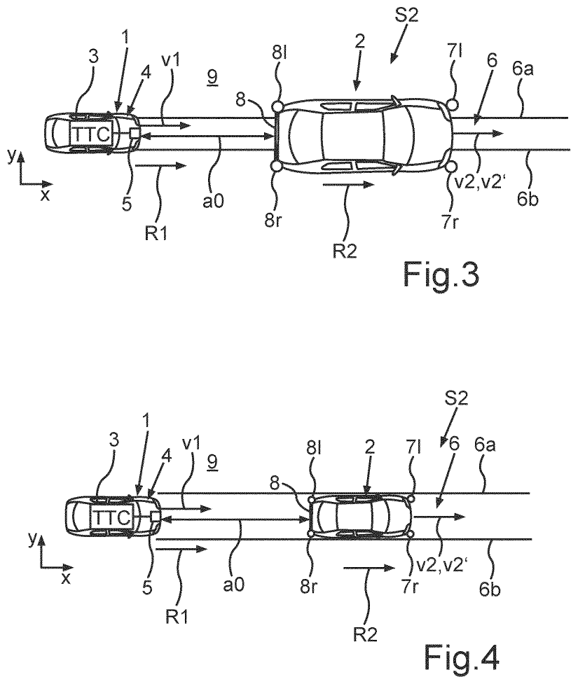

FIG. 3 shows a schematic illustration of the motor vehicle from FIG. 1 in a further traffic situation with a second motor vehicle according to an exemplary embodiment of the invention; and

FIG. 4 shows a schematic illustration of the motor vehicle from FIG. 1 in a further traffic situation with a second motor vehicle according to an exemplary embodiment of the invention.

FIG. 1 shows a schematic illustration of a first motor vehicle 1 and an object 2, likewise formed as a second motor vehicle 2 in this example, at two different points in time t1, t2 to illustrate a method according to an exemplary embodiment of the invention for calculating a predicted time until a possible collision of the first motor vehicle 1 with the second motor vehicle 2. The first motor vehicle 1 further has a control device 3 as part of a driver assistance system 4 of the motor vehicle 1, wherein the control device is designed to carry out the method described below for calculating the time TTC until the possible collision, wherein the possible collision will also to some extent be simply called a collision below. Furthermore, the driver assistance system 4 can also further comprise at least one vehicle surroundings sensor 5 of the motor vehicle 1. On the basis of the sensor data provided by the vehicle surroundings sensor 5, information about the surroundings 9 of the motor vehicle 1 and in particular also the second motor vehicle 2 can be provided to the control device 3. In order to ascertain whether there is a risk of collision, the control device 3 can firstly ascertain a travel envelope 6 of the first motor vehicle 1. This travel envelope 6 is delimited in the lateral direction, which means perpendicular to the current movement direction, by two boundary lines 6a, 6b. The current movement direction of the first motor vehicle 1 in this example is represented by the illustrated x direction. The motor vehicle 1 continues to travel in the x direction at a speed v1. The travel envelope 6 has a width in the y direction which corresponds to the width of the motor vehicle 1. Accordingly, the travel envelope 6 describes a predicted area which the motor vehicle 1 will cover during a future movement. If there are objects in this travel envelope 6, such as at least partly the second motor vehicle 2 in this example, a collision with such objects is accordingly likely.

By means of the sensor 5 which, for example, can be a lidar, radar, ultrasonic sensor and/or a camera, the second motor vehicle 2 in the surroundings 9 of the motor vehicle 1 can be detected. Furthermore, it is possible to establish whether or when this second motor vehicle 2 enters the travel envelope 6 of the first motor vehicle 1. During a time interval during which at least part of this second motor vehicle 2 is located in the travel envelope 6, the control device 3 correspondingly calculates the anticipated time TTC until the collision with this second motor vehicle 2 in respective successive time steps, such as the time steps t1, t2 illustrated here by way of example. This will now be described in more detail below.

Firstly, for this purpose, the second motor vehicle 2 can be modeled mathematically and represented by its four corners 7l, 7r. 8l, 8r. All the corners 7l, 7r. 8l, 8r of the second motor vehicle 2 do not necessarily always have to be detected simultaneously by the sensor 5 or be visible to the sensor 5. The calculation method described below can also be carried out when not all of these corners 7l, 7r, 8l, 8r are detected. However, it is advantageous if at least one of the front corners 7l, 7r and one of the rear corners 8l, 8r is detected and used for the representation of the second motor vehicle 2. In addition, a connecting line between the front corners 7l, 7r is designated by 7 in the present case.

In FIG. 1, the motor vehicle 2 moves in a second movement direction R2 at the speed v2 and in the process crosses the travel trajectory of the first motor vehicle 1 at an angle. Accordingly, this second motor vehicle 2 crosses the travel envelope 6 of the first motor vehicle 1. At the first time step t1, only the front right corner 7r of the second motor vehicle 2 is in the travel envelope 6. If the second motor vehicle 2 travels further in the second movement direction R2, then ultimately also the front left corner 7l will enter the travel envelope 6, then the front right corner 7r will leave the travel envelope 6 again on the opposite side, the front left corner 7l likewise, then the rear right corner 8r will enter the travel envelope 6, as illustrated for the second time step t2 in FIG. 1, then also the rear left corner 8l, and then, in a corresponding manner, both rear corners 8r, 8l will also again leave the travel envelope 6 one after another on the opposite side. This is at least the case if no collision with the first motor vehicle 1 occurs in the meantime.

In this example, the second movement direction R2 is at least partly opposed to the first movement direction R1 of the first motor vehicle 1. In other words, the speed v2 of the second motor vehicle 2 has a speed component v2′ which is opposite to the speed v1 of the first motor vehicle 1. The result of this is that as soon as a front corner 7l, 7r of the second motor vehicle 2, the right corner 7r in this example, enters the travel envelope 6, the distance a1 decreases increasingly as the second motor vehicle 2 travels further, even if the first motor vehicle 1 were not to travel onward. This distance a1, which in the present case corresponds to the first point in time t1, decreases because of the onward travel of the second motor vehicle 2 until at least one front corner 7l, 7r is located in the travel envelope 6. If, on the other hand, the two front corners 7l, 7r have left the travel envelope 6 again on the opposite side and if the motor vehicle 2 travels onward, then no further reduction in the distance takes place because of the further movement of the motor vehicle 2. The distance corresponding to the second point in time t2 is designated by a2 here. Therefore, as long as or as soon as the front corners 7l. 7r are located outside the travel envelope 6, the vehicle 2, in particular its rear corners 8l, 8r, can be viewed as static. In this case, the decrease in the distance a2 can be attributed only to the speed v1 of the first motor vehicle 1. In this case, which is also designated as the first situation S1 below, the time TTC until the collision can therefore be ascertained exclusively on the basis of the absolute speed v1 of the first motor vehicle 1, in this example simply as:

$$TTC = a 2 / v 1.$$

In the previously described situation, which will also be designated as the second situation S2 below, the time TTC until the collision must, however, be ascertained as a function of the relative speed between the first and the second motor vehicle 1, 2, for example according to:

$$TTC = a 1 / ( v 1 - v {2}^{′} ) .$$

This applies at least when, during this time TTC until the possible collision, there is no change in the situation, in this example from the second situation S2 to the first situation S1. Otherwise, the ascertained time TTC until the collision can also be composed of individual time sections ascertained corresponding to the respective situations S1, S2.

The relative speed therefore represents the difference between the first speed v1 of the first motor vehicle 1 and the component v2′ parallel thereto of the second speed v2 of the second motor vehicle 2.

FIG. 2 shows a further illustration of a traffic situation with the first vehicle 1 and the second vehicle 2. These vehicles 1, 2 and in particular the driver assistance system 4 can be designed as already previously described. In this case, the movement direction R2 of the second motor vehicle 2 is directed such that the speed v2 of the second motor vehicle 2 has a component v2′ which is directed parallel to the first speed v1 and points in the same direction as the first movement direction R1 of the first motor vehicle 1. The second motor vehicle 2 is once more illustrated for two time steps t1, t2, wherein the second time step t2 lies chronologically after the first time step t1. Here, too, the vehicle 2 is once more represented by its corresponding corners 7l, 7r, 8l, 8r, and the connecting line between the rear corners 8r. 8l is designated by 8. As long as the rear corners 8l, 8r and their connecting line 8 are located outside the travel envelope 6, the second motor vehicle 2 can be assumed to be static, since no decrease in the distance a1 to the first motor vehicle 1 caused by the movement of the second motor vehicle 2 takes place. The shortest distance a1 to the second motor vehicle 2 in this example is thus always located along the lower boundary lines 6b of the travel envelope 6 at the location of the second motor vehicle 2. However, this situation changes as soon as a rear corner 8l, 8r, in this example the left rear corner 8l, enters the travel envelope 6 or reaches the boundary lines 6b. Beginning at this point in time, an additional decrease in the distance a2 to the motor vehicle 1 caused by the movement of the second motor vehicle 2 takes place. Thus, the situation illustrated on the right in FIG. 2 corresponds to the first situation described in relation to FIG. 1 in which, to calculate the time TTC until the collision, only the absolute speed v1 of the first motor vehicle 1 has to be taken into account, while the second vehicle 2 illustrated on the left corresponds to the second situation S2 described in relation to FIG. 1, in which the speed or the speed component v2′ of the second motor vehicle 2 must also additionally be taken into account in the calculation of the time TTC until the collision.

Depending on the situation S1, S2, the time TTC until the collision can therefore be calculated simply according to one of the above-described formulas. In general, the time TTC until the collision or its possible individual time sections from which this is composed, depending on the situation S1, S2, can therefore be calculated either as a function of only the absolute speed v1 of the first motor vehicle 1 or as a function of the relative speed between the first and the second motor vehicle 1, 2. Which of the two situations S1, S2 this is can be ascertained in a simple way as a function of the second movement direction R2 relative to the first movement direction R1, and as a function of the position of the respective corners 7l, 7r, 8l, 8r of the second motor vehicle 2. Therefore, if the second movement direction R2 is at least partially opposite to the first movement direction R1, and if both front corners 7l, 7r are not within the travel envelope 6 and on the same side of the travel envelope 6, then this is the first situation S1, and otherwise the second situation S2. On the other hand, if the second movement direction R2 is at least partly aligned with the first movement direction R1, then this is the first situation S1, as long as none of the rear corners 8l, 8r are located within the travel envelope 6 and the rear corners 8l, 8r are additionally located on the same side of the travel envelope 6. Otherwise, this is the second situation S2.

The overall time interval in which the second vehicle 2 is at least partly located in the envelope 6 can thus be divided, for example, into two partial intervals, wherein one can be assigned to the first situation S1 and one to the second situation S2. This applies at least when the first and the second vehicle 1, 2 are not absolutely parallel to each other and do not travel perpendicularly to each other. These cases will be described below.

FIG. 3 shows another special case. Once more, the first and the second motor vehicle 1, 2, which can likewise be designed as previously described, are illustrated here. In this example, the second motor vehicle 2 is so wide that its corners 7l, 7r, 8l, 8r are no longer located within the travel envelope 6. Nevertheless, the motor vehicle 2 is at least partly located in the travel envelope 6, and so a collision is possible. Since, in this case, the first and the second movement direction R1, R2 are parallel to each other, the relative speed between the two vehicles 1, 2 likewise has to be taken into account here to ascertain the time TTC until the collision. The second situation S2 is therefore present here again. Although, in this case, neither of the rear corners 8l, 8r is located within the travel envelope 6, the rear corners 8l, 8r are not on the same side of the travel envelope either. In other words, here a connecting line 8 which connects the rear corners 8l, 8r is thus at least partly located within the travel envelope 6. The distance between the two motor vehicles 1, 2 is designated by a0 here.

FIG. 4 shows a further traffic situation with the first motor vehicle 1 and the second motor vehicle 2, which can likewise be designed as previously described. In this example too, the second movement direction R2 is parallel to the first movement direction R1 and additionally also aligned with the latter.

The second motor vehicle 2 is now considerably smaller than in the previously described example, so that now the corners 7l, 7r, 8l, 8r or at least one of the rear corners 8l, 8r are/is also arranged in the travel envelope 6. The second vehicle 2, in particular in this example, travels exactly in parallel with the first motor vehicle 1 in the same lane in front of the first motor vehicle 1. In the event of a collision, the first motor vehicle 1 will collide first with the rear corners 8r, 8l of the second motor vehicle 2. The rear corners 8l, 8r are already located in the travel envelope 6 and would be the last to leave the travel envelope 6. Therefore, the time interval in which the relative speed must be taken into account to calculate the time TTC until the collision represents the total time interval in which the second vehicle 2 is at least partly located in the envelope 6. Accordingly, in this example, the second situation S2 is once more present, in which the relative speed between the two vehicles 1, 2 must be taken into account in order to ascertain the time TTC until the collision. Here, too, the distance between the two motor vehicles 1, 2 is designated by a0.

Therefore, the ascertainment or calculation of the time TTC until the collision, at least when no change in the situation takes place during the time TTC until the possible collision, can be constituted as follows.

$$TTC = \{ \begin{matrix}\frac{a}{\vert v 1 \vert} & for the first situation S 1 \\ \frac{a}{\vert v 1 \vert - \vert v 2 \vert cos α} & for the second situation S 2\end{matrix}$$

a denotes the distance between the first and the second motor vehicle, which is illustrated in FIG. 1 and FIG. 2 by a1 and a2 and is illustrated in FIG. 3 and FIG. 4 by a0, |v1| is the magnitude of the first speed v1 and |v2| is the magnitude of the second speed v2, and a is the angle illustrated in FIG. 1 to FIG. 4 between the first speed v1 and the second speed v2 or between the speed vectors representing these speeds, in the counterclockwise direction.

The situation in which the second motor vehicle 2 would, for example, cross the travel envelope 6 perpendicularly, which would correspond to an angle α=90°, can be interpreted as the first or as the second situation S1, S2, since this would lead to the same result. In other words, in this situation only the absolute speed of the first motor vehicle 1, which means therefore v1, is likewise relevant. In other words: In the case of a crossing at the 90° angle, the second vehicle 2 therefore travels at a 90° angle to the first vehicle 1. The relative speed is therefore equal to the absolute speed v1 of the first vehicle 1. Therefore, for both time intervals, the results are the same as when the calculation is carried out while taking account of only the absolute speed v1.

It should additionally be noted that when the second vehicle 2 leaves the travel envelope 6 toward the side, there is no plausible calculation of the relative speed for this last point of intersection between the second motor vehicle 2 and the travel envelope 6, since the vehicle 2 leaves the travel envelope 6 and a time TTC until the collision, which lies in the future, cannot lead to a collision.

Overall, the examples show how, by means of the invention, efficient calculation of the time until the collision by using absolute and relative speeds of the potentially extended target vehicle can be provided for automatic emergency braking assistance functions. The invention has the advantage that the discretized prediction of the positions along the trajectories of the vehicles, which is very time-consuming and memory-intensive, can be avoided while, nevertheless, a generic algorithm for the calculation of the time until the collision can be followed. Only two cases need to be taken into account for the definition of time intervals and, after that, the two time intervals can be calculated in a generic way.

1. A method for calculating a predicted time until a possible collision between a first motor vehicle moving in a first movement direction and an object moving in a second movement direction, the method comprising:
ascertaining a travel envelope of the first motor vehicle, which describes a predicted area located in front of the first motor vehicle in the first movement direction and over which the first motor vehicle will travel during a future movement of the first motor vehicle;
representing the object by four corners forming a quadrilateral, which are divided into two front corners and two rear corners with respect to the second movement direction;
for at least one point in time within a time interval during which at least part of the object is located in the travel envelope, ascertaining the time until the possible collision;
ascertaining, in a specific first situation, for at least one first point in time during the time interval, the time until the possible collision as a function of a current absolute first speed of the first motor vehicle at this first point in time and irrespective of a second speed of the object; and
ascertaining, in a specific second situation, for at least one second point in time during the time interval, the time until the possible collision as a function of a current relative speed between the first motor vehicle and the object with respect to the first movement direction at the second point in time,
wherein, depending on a respective position of the four corners relative to the travel envelope, a determination is made as to whether this is the first or the second situation.

2. The method as claimed in claim 1, further comprising:
for a case in which, within the time interval,
directing the second movement direction of the object perpendicular to the first movement direction; and
determining the time until the possible collision as a function of the current absolute first speed of the first motor vehicle, which corresponds to the current relative speed.

3. The method as claimed in claim 1 wherein if the possible collision has not yet taken place, the time until the possible collision is repeatedly ascertained for successive time steps.

4. The method as claimed in claim 3, further comprising:
for each of the time steps, depending on a current position of the four corners, classifying whether this is the first situation or the second situation.

5. The method as claimed in claim 1, further comprising:
determining a presence of the first or the second situation as a function of the current position of the four corners in such a way that, depending on which of the four corners is located in the travel envelope; and
classifying whether this is the first situation or the second situation.

6. The method as claimed in claim 1, further comprising:
in addition, depending on whether, within the time interval, the second movement direction of the object is at least partly directed in the first movement direction or opposite to the first movement direction; and
determining whether this is the first or the second situation.

7. The method as claimed in claim 1, further comprising:
for a case in which, within the time interval, the second movement direction of the object points at least partly in the same direction as the first movement direction (R1),
determining the first situation is occurring if none of the rear corners of a representation of the object are located in the travel envelope and the rear corners are located on the same side of the travel envelope; and
determining the second situation is occurring if a connecting line connecting at least one rear corner or at least part of one of the rear corners is located in the travel envelope.

8. The method as claimed in claim 1, further comprising:
for a case in which, within the time interval, the second movement direction of the object is at least partly opposed to the first movement direction,
determining the first situation is occurring if none of the front corners of a representation of the object is located in the travel envelope and the front corners are located on the same side of the travel envelope; and
determining the second situation is occurring if at least one of the front corners and/or at least part of a connecting line connecting the front corners is located in the travel envelope.

9. The method as claimed in claim 1, further comprising:
directing at least when the second movement direction of the object neither completely perpendicular nor completely parallel to the first movement direction; and;
dividing the time interval into two partial intervals, depending on which of the four corners are currently located in the travel envelope,
wherein, in a first partial interval of the two partial intervals, arises the first situation, and
wherein, in a second partial interval of the two partial intervals, arises the second situation.

10. The method as claimed in claim 1, further comprising:
ascertaining the time until the collision as a function of a current distance between the first motor vehicle and the object along the travel envelope.

11. The method as claimed in claim 1, further comprising:
ascertaining a movement path for the object;
ascertaining an area of intersection of the movement path with the travel envelope;
ascertaining a point in time at which the first motor vehicle reaches the area of intersection; and
classifying the collision as possible when the point in time lies after an entry time at which the object enters the travel envelope and before an exit time at which the object leaves the travel envelope.

12. The method as claimed in claim 1, further comprising:
ascertaining the time until the possible collision by a control device associated with the first motor vehicle; and
providing, to the control device, the current first speed, the second movement direction relative to the first movement direction, a distance to the object and, the second speed as input variables for each time step.

13. The method as claimed in claim 1, further comprising:
providing, by at least one vehicle surroundings sensor of the first motor vehicle, sensor data relating to the object, depending on which data the second movement direction relative to the first movement direction; and
ascertaining a distance to the object and the second speed.

14. A non-transitory computer readable medium comprising a computer program comprising commands which, when they are executed by a computing unit, cause the computing unit to carry out the method as claimed in claim 1.

15. A driver assistance system for a motor vehicle, wherein the driver assistance system is configured to carry out the method as claimed in claim 1.
